(19) United States
(12) Patent Application Publication
(10) Pub. No.: US 2004/0174999 A1
(43) Pub. Date: Sep. 9, 2004

(54) Image data encryption method and apparatus, computer program, and computer-readable storage medium

(75) Inventors: Keiichi Iwamura, Kanagawa (JP); Yuji Suga, Kanagawa (JP); Junichi Hayashi, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/792,799

(22) Filed: Mar. 5, 2004

(30) Foreign Application Priority Data
Mar. 7, 2003 (JP) 2003-061864
Feb. 12, 2004 (JP) 2004-035546

(51) Int. Cl. H04K 1/00

(52) U.S. Cl. 380/277

(57) ABSTRACT

This invention provides an image data encryption technique which facilitates management of access keys in encrypting image data having a hierarchical structure in which the data of each layer can be specified by at least two parameters, and is resistant against exchange of access keys between a plurality of users. To implement this technique, in this invention, in encrypting image data having a hierarchical structure in which a layer is specified by layer and resolution levels, an access key K for the highest resolution and highest layer is set. Access keys are generated by using a one-way function in a direction which the level becomes low. The access key for a given layer can be generated from either of the access keys of layer and resolution located at the higher level. The data of each layer is encrypted in accordance with a corresponding access key.

### FIELD OF THE INVENTION

The present invention relates to an image data encryption technique.

### BACKGROUND OF THE INVENTION

To secretly transmit image data or the like, entire image data is encrypted or scrambled. This is also a technique for encrypting entire image data by using an encryption key and allows only a computer which has the information of a decryption key corresponding to the encryption key to correctly decrypt the image data.

When image data is constituted by a plurality of tiles, encryption processing is executed for the respective tiles by using different encryption keys in order to control the possibility of reconstruction for each tile.

For image data having a hierarchical structure, encryption processing is executed for the respective layers by using different encryption keys in order to control reconstruction of the image data in accordance with the hierarchical structure.

The hierarchy is sometimes determined by a plurality of parameters. For example, in a technique called a JPEG2000 standard which is standardized by ISO/IEC JTC 1/SC 29/WG1, one hierarchical structure data is defined when four parameters, i.e., a resolution, a layer as a set of codes for bit planes, a component representing a color component or the like, and a precinct representing a position in a tile are determined for one tile. As a combined example, for image data formed from a plurality of tiles each of which has a hierarchical structure, encryption processing is executed for the respective layers in each tile by using different encryption keys in order to control reconstruction of the image data in accordance with the tile and hierarchical structure.

When tiles and layers are encrypted by using different encryption keys, reconstruction of image data can be controlled for each tile and each layer. However, to decrypt a predetermined tile and a predetermined layer of encrypted image data, all encryption keys used for encryption processing must be managed. In addition, an appropriate decryption key must be supplied in decryption processing. Key information management on each of the encryption side and decryption side readily becomes cumbersome.

There is a method of facilitating management of key information, in which keys related to a tile, component, and precinct are generated independently, and keys related to a resolution and layer are generated depending on the keys of the preceding and succeeding resolutions and layers. A tile, component, or precinct is accessed at random at a high probability. Keys for them are generated in accordance with identifiers which identify the parameters. As for a resolution or layer, to reconstruct an image of high resolution or high layer, access to image data of low resolution or low layer is necessary. Hence, a key which encrypts data of resolution or layer lower by one step is generated from a key which encrypts data of higher resolution or layer, thereby decreasing the number of keys to be managed.

In this method, let K be the master key related to one image. A key Ki for each tile, component, or precinct is generated in the following way by using a one-way function. In a one-way function y=H(x), y can easily be obtained from x, though x can hardly be obtained from y. As the one-way function, a hash function such as MD5 (Message Digest 5) or SHA-1 (Secure Hash Algorithm 1) or an encryption function such as DES (Data Encryption Standard) or AES (Advanced Encryption Standard) is known.

Ki=H(K∥i) (1)

where H( ) represents a one-way function, x∥y represents concatenation between x and y, and i is a value (identification information) to identify a tile, component, or precinct.

The key Ki for a resolution or layer is generated by

Ki=H(Ki−1) (2)

where i is a value representing a target resolution or layer, and Ki−1 is a key which is used for a resolution of one step before (a resolution higher than the resolution of interest) or a layer of one step before (a layer higher than the layer of interest).

Let Ktcpr1 be the encryption key for a designated tile and layered data, and KT, KC, KP, KR, and KL be the keys for the designated tile, component, precinct, resolution, and layer. The encryption key Ktcpr1 is generated by

Ktcpr1=H(KT∥KC∥KP∥KR∥KL) (3)

As described above, when target tiles and hierarchical structures are encrypted by using different encryption keys, image data reconstruction can be controlled for each tile or hierarchical structure.

However, when the tiles and hierarchical structures are encrypted by using different encryption keys, leakage of keys by conspiracy of users to be described below occurs for resolutions and layers.

For example, as shown in FIG. 1, a key KRn for the highest resolution and a key KL0 for the lowest layer are transferred to a user A. A key KR0 for the lowest resolution and a key. KLm for the highest layer are transferred to a user B. Normally, the user A cannot access high layer data of KL0 or more because of equation (2), and the user B cannot access high resolution data of KR0 or more.

More specifically, referring to FIG. 1, the user A can access (decrypt) only R0L0, R1L0, . . . , RnL0, and the user B can access only R0L0, R0L1, . . . , R0Lm.

However, if the users A and B tell the keys KLn and KRn to each other, the users A and B can eventually reconstruct the images of all resolutions and layers because all keys for lower resolutions or layers can be generated by using the keys KLn and KRn. That is, the users can access the whole range from R0L0 to RnLm in FIG. 1.

The above-described example may be an extreme. However, in the Internet environment where many unspecified users can communicate with each other, such an unexpected incident can occur.

### SUMMARY OF THE INVENTION

The present invention has been made in consideration of the above problem, and has as its object to provide an image data encryption technique which facilitates management of access keys in encrypting image data having a hierarchical structure in which the data of each layer can be specified by at least two parameters, and is resistant against exchange of access keys between a plurality of users.

In order to achieve the above problem, an image data encryption method of the present invention comprises, e.g., the following steps.

An image data encryption method of encrypting image data by using key information comprises:

an input step of inputting image data which has a hierarchical structure and in which data of each layer can be specified by at least two parameters, and each parameter is expressed by multilevels;

a setting step of setting, for the input image data, key information for data of a layer in which both of the two parameters are specified by maximum levels;

a generation step of, by using the key information set in the setting step as an origin and by using a predetermined one-way function, generating key information for data of a layer specified by the two parameters, in accordance with key information for a layer which is located at a level higher by one step than the data of the layer; and

an encryption step of encrypting data of a layer of interest, which is input in the input step, in accordance with the key information set in the setting step and the key information generated in the generation step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view for explaining a problem of key information for resolutions and layers in a prior art;

FIG. 2 is a view showing the correlation of key information for resolutions and layers according to the first embodiment;

FIG. 3 is a block diagram showing the arrangement of an apparatus according to the first embodiment;

FIG. 4 is a view showing the correlation of keys when RSA encryption is used in the first embodiment;

FIG. 5 is a block diagram showing an arrangement for encryption and key generation according to the first embodiment;

FIG. 6 is a view showing a system configuration used in the embodiment;

FIG. 7 is a view showing an example of wavelet transform;

FIG. 8 is a view for explaining layers in entropy encoding;

FIG. 9 is a block diagram schematically showing the arrangement of a key information processing apparatus according to the second and third embodiments;

FIG. 10 is a view for explaining an example of a digraph according to the second embodiment;

FIG. 11 is a view showing an example of a key distribution graph according to the second embodiment;

FIG. 12 is a view showing an example of a key distribution matrix according to the second embodiment;

FIG. 13 is a view for explaining an example of node division in the key distribution graph shown in FIG. 10 according to the second embodiment;

FIG. 14 is a view of a key distribution matrix which represents a halfway state of formation of the key distribution matrix according to the second embodiment;

FIG. 15 is a view of a key distribution matrix which represents a halfway state of formation of the key distribution matrix according to the second embodiment;

FIG. 16 is a view of a key distribution matrix which represents a halfway state of formation of the key distribution matrix according to the second embodiment;

FIG. 17 is a view showing another example of node division in the key distribution graph shown in FIG. 10 according to the second embodiment;

FIG. 18 is a view showing another example of the key distribution matrix according to the second embodiment;

FIG. 19 is a flow chart showing a node key generation sequence according to the second embodiment;

FIG. 20 is a view for explaining a hierarchical access structure according to the third embodiment;

FIG. 21 is a table showing an image list to be encrypted by nodes according to the third embodiment;

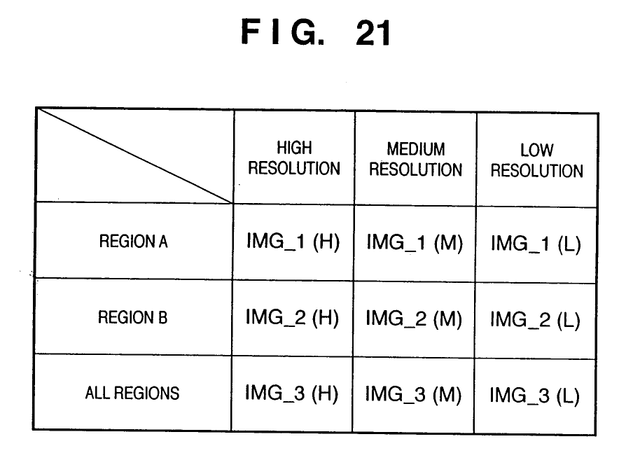

FIG. 22 is a view for explaining a binary tree structure in a tree structure management method;

FIG. 23 is a view for explaining an access structure in a hierarchical access control method;

FIG. 24 is a view for explaining an access structure in the hierarchical access control method;

FIG. 25 is a view for explaining a local structure in the hierarchical access control method;

FIG. 26 is a view for explaining an example of user multiple keying;

FIG. 27 is a view for explaining one-way function based keying schemes;

FIG. 28 is a view showing an example of a digraph according to the second embodiment;

FIG. 29 is a view for explaining an example of node division in the key distribution graph shown in FIG. 10 according to the second embodiment;

FIG. 30 is a view showing an example of a key distribution graph according to the second embodiment;

FIG. 31 is a view of a key distribution matrix which represents a halfway state of formation of the key distribution matrix according to the second embodiment;

FIG. 32 is a view of a key distribution matrix which represents a halfway state of formation of the key distribution matrix according to the second embodiment;

FIG. 33 is a view of a key distribution matrix which represents a halfway state of formation of the key distribution matrix according to the second embodiment;

FIG. 34 is a view of a key distribution matrix which represents a halfway state of formation of the key distribution matrix according to the second embodiment;

FIG. 35 is a view showing another example of the key distribution graph according to the second embodiment;

FIG. 36 is a view showing an example of a digraph according to the second embodiment, in which nodes having a bidirectional connection relationship are present; and

FIG. 37 is a view showing an example of a digraph which is changed from the digraph shown in FIG. 36 according to the second embodiment so that no nodes having a bidirectional connection relationship are present.

### DETAILED DESCRIPTION OF THE PREFERRED EMBODIMENTS

The embodiments according to the present invention will be described below with reference to the accompanying drawings.

<Description of Overall Arrangement>

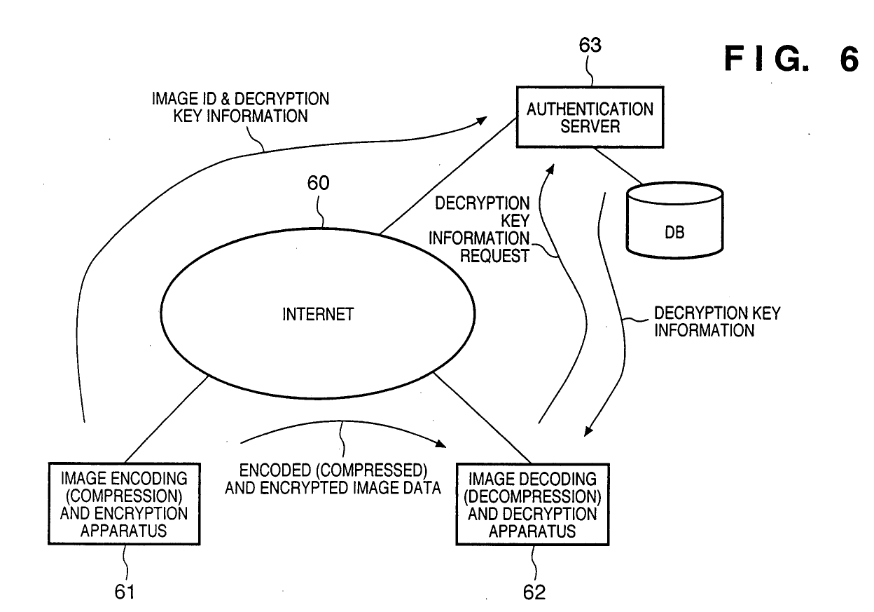

FIG. 6 shows the schematic arrangement of a system according to an embodiment. Referring to FIG. 6, reference numeral 60 denotes Internet. An image encoding (compression) and encryption apparatus 61 encodes (compresses) and encrypts image data sensed by, e.g., a digital camera, image scanner, or film scanner. An image decoding (decompression) and decryption apparatus 62 receives image data and decodes (decompresses) and decrypts it. An authentication server 63 stores a decryption key which is necessary for decoding (decompression) and decryption. Each of the apparatuses 61 to 63 can be a general-purpose apparatus such as a personal computer. The flow of processing will briefly be described below.

The apparatus 61 executes encoding (compression) and encryption processing for desired image data and distributes it through the Internet 60. The distribution may be done either directly by the apparatus 61 or through an appropriate server. Since the image data is encrypted, key information which is necessary for decrypting the image data is registered in advance in a DB in the authentication server 63 together with information (e.g., an ID) which specifies the image data. The image decoding (decompression) and decryption apparatus 62 receives a desired image, decodes (decompresses) and decrypts the image data, and browses it. To browse encrypted image data, the apparatus 62 sends information which specifies the image to the authentication server 63 and requests decryption key information. As a result, the decryption key information is received from the authentication server 63. The apparatus 62 decrypts and decodes (decompresses) the image data by using the decryption key information.

In the embodiment, for the descriptive convenience, an image (file) to be encrypted is assumed to be data encoded (compressed) by an encoding (compression) method which is standardized by ISO/IEC JTC 1/SC 29/WG1 10918-1 and popularly called JPEG2000. However, the present invention is not limited to JPEG2000, and various encoding (compression) methods such as JPEG can be used, as will be apparent from the following description. The arrangement of the apparatus 61 will be described.

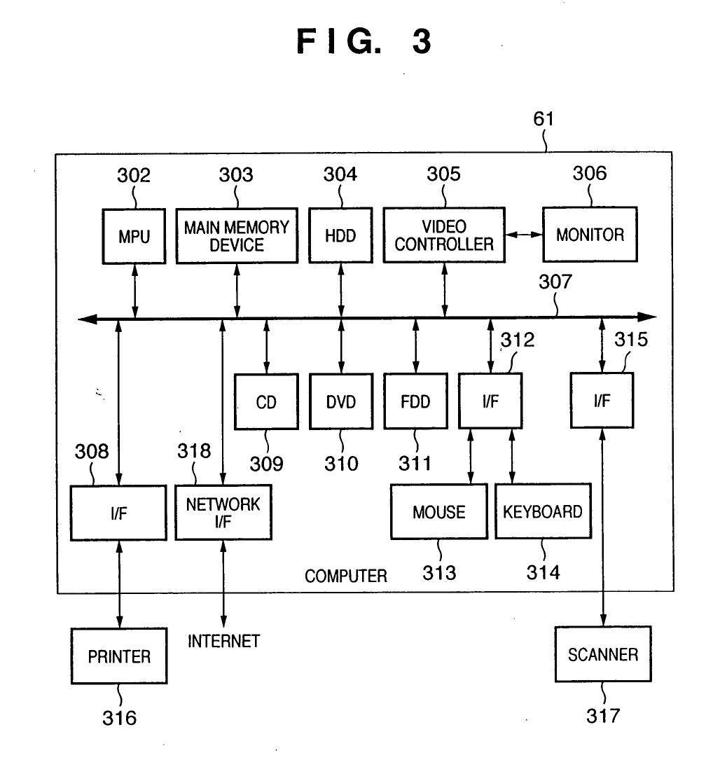

The apparatus 61 can be a general-purpose information processing apparatus such as a personal computer, as described above. FIG. 3 shows its detailed arrangement.

Referring to FIG. 3, reference numeral 302 denotes an MPU which controls the entire apparatus; and 303, a main memory device (it includes a RAM in which the working area of the MPU 302, an OS, and an encryption processing program of this embodiment are loaded, and a ROM which stores a boot program and BIOS). A hard disk device (HDD) 304 stores various kinds of files in addition the OS and encryption processing program. Reference numeral 305 denotes a controller which bitmaps data on a video memory under the control of the memory and the MPU 302 or a video controller which outputs, as a video signal, the data bitmapped on the memory to a monitor 306 serving as a display device. The monitor 306 can be either integrated with the apparatus or an external device. Reference numeral 307 denotes a system bus.

Reference numeral 308 denotes an interface connected to a printer 316; 309, a CD-ROM drive; 310, a DVD drive; 311, a floppy (registered trademark) drive; 312, an interface connected to a pointing device 313 such as a mouse (registered trademark) and a keyboard 314; 315, an interface connected to an image scanner 317; and 318, a network interface connected to the Internet 60.

In this embodiment having the above arrangement, for example, an original is read by the scanner 0.317, and the read result is distributed, as described above. However, the object to be encrypted is not limited to data read by the image scanner 317. Image data read out from a storage medium such as a CD-ROM or an image sensed by a digital camera connected to the apparatus may be used. That is, the image data to be encrypted can be input by any means.

<Description of Encryption Key>

In the embodiment having the above arrangement, encryption is executed for an image data file which is encoded (compressed) by a technique called a JPEG2000 standard which is standardized by ISO/IEC JTC 1/SC 29/WG1. This compression technique itself is known, and a detailed description thereof will be omitted.

In JPEG2000, one hierarchical structure data is defined when four parameters, i.e., a resolution, a layer as a set of codes for bit planes, a component representing a color component or the like, and a precinct representing a position in a tile are determined for one tile. In this embodiment, encryption is executed for compressed image data having such a hierarchical structure.

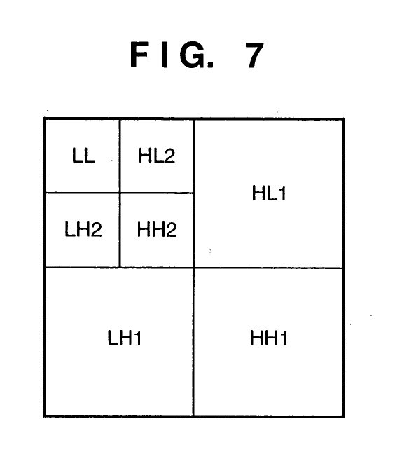

FIG. 7 shows frequency components obtained when wavelet transform is performed twice for a given tile. When the first wavelet transform is performed, four sub-band data HL1, HH1, LH1, and LL1 are obtained. In the second wavelet transform, the same processing as in the first wavelet transform is performed for LL1. The number of LL components is always one, and therefore, no suffix is added to the component. The data of the LL component is data of a low frequency component. The image size is ¼ the original tile size in both the vertical and horizontal directions. More specifically, the LL component shown in FIG. 7 can be regarded as having a resolution of ¼ (minimum resolution) of the image represented by the tile. When the data of the LL component is decrypted by using the data of {HL2+HH2+LH2}, an image having a resolution higher by one step can be reconstructed. When the data is reconstructed by using the data of {HL1+HH1+LH1}, an image having the highest resolution corresponding to the original tile size can be reconstructed. More specifically, the resolution of data gradually increases in the order of LL, {HL2+HH2+LH2}, and {HL1+HH1+LH1}. Actually, after the wavelet transform, quantization processing is executed to convert the value in each component to a smaller number of bits. Then, entropy encoding is executed.

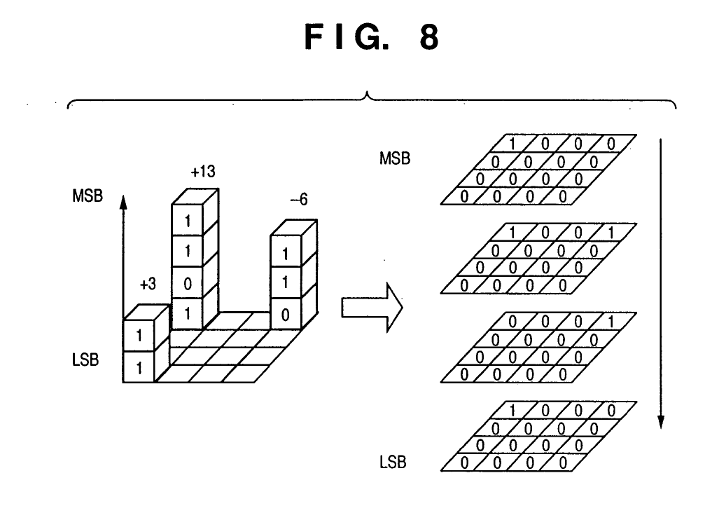

FIG. 8 shows quantized data. For the illustrative convenience, data having a size of 4×4 is shown as quantized data. In this example, three quantization indices are present, which have values of +13, −6, and +3, respectively. In entropy encoding, a maximum value MAX of these values is obtained. A number S of bits necessary for expressing the maximum quantization index is calculated by

S=ceil(log2(abs(MAX)))

where ceil(x) is a function representing the smallest integer value in integers equal to or more than x. Referring to FIG. 8, since the maximum coefficient value is 13, S is 4. The 16 quantization indices in the sequence are processed for each of four bit planes, as indicated on the right side in FIG. 8. First, an entropy encoding unit entropy-encodes (in this embodiment, binary-arithmetic-encodes) each bit of the most significant bit plane (MSB in FIG. 8) and outputs it as a bitstream. The level of bit plane is decreased by one. In the same way as described above, each bit in the bit plane is encoded (compressed) and output to a codestream output unit until the target bit plane reaches the least significant bit plane (LSB in FIG. 8). In the above entropy encoding, in bit plane scanning from the upper to lower level, when a non-zero bit to be encoded (compressed) first (higher level) is detected, one bit representing the sign of the quantization index is added immediately after the non-zero bit, and binary arithmetic encoding (compression) is executed. With this processing, the signs of quantization indices other than zero can efficiently be encoded.

In the example shown in FIG. 8, four planes of bits 0 to 3 are generated. A bit plane of higher level is more dominant so that the most significant bit plane (the plane of bit 3 in FIG. 8) corresponds to the above-described low resolution data, and the plane of bit 0 corresponds to data to be used to reconstruct the highest resolution data. A processing unit (bit plane) obtained by collecting entropy-encoded entropy codes in a predetermined code amount will be called a layer. When a plurality of layers are formed, images corresponding to various code amounts can be reconstructed in decryption.

A codestream of data encoded (compressed) by JPEG2000 has a main header at the first position. At least one data called a tile-part indicated by four parameters, i.e., a resolution, a layer, a component representing a color component or the like, and a precinct follows the main header. A tile-part incorporates a tile-part header and at least one code-block.

In a code-block of this embodiment, information representing a resolution level and layer is contained in the tile-part header. By using this information encryption key information to be used is specified, and encryption is executed.

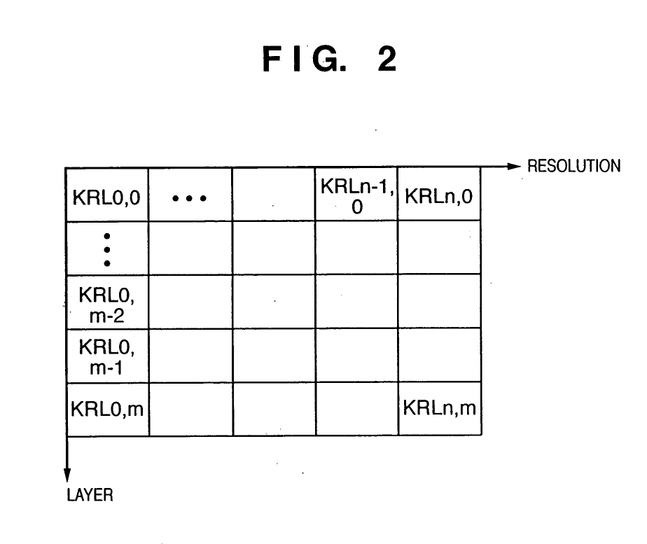

Referring to FIG. 2, KRLij indicates access key information to RiLj which represents layered data corresponding to a predetermined resolution and layer. For the access key KRLij corresponding to a given resolution and layer, keys are updated by

KRLi−1,j=F(a,KRLij) (4)

KRLi,j−1=F(b,KRLij) (5)

where F( ) is a one-way function using a key a or b. A relation given by

F(a,F(b,K))=F(b,F(a,K)) (6)

holds.

The relation (6) cannot be implemented by the above-described hash function such as MD5 (Message Digest 5) or SHA-1 (Secure Hash Algorithm 1) or encryption function such as DES (Data Encryption Standard) or AES (Advanced Encryption Standard).

This relation is implemented by the following calculation. Assume that N=(p−1)(q−1) (p and q are prime numbers), and a and b are open to the public.

(K\hat{ }b)\hat{ }a mod N=(K\hat{ }a)\hat{ }b mod N (7)

where “x\hat{ }y” represents x raised to the yth power, and “x mod y” is a function which returns a remainder when x is divided by y (“\hat{ }” indicates an arithmetic coupling strength higher than “mod”).

Equation (7) is based on the same principle as RSA encryption. Even when a and b are open to the public, no inverse operation can be performed unless a′ and b′ corresponding to private keys are known. Hence, the unidirectional property is guaranteed.

This solves the following problem in the conventional method.

i. An access key KRLn0 is transferred to a user A who can access the data of highest resolution and lowest layer. The user A can generate access keys KRLn-1,0 to KRL00 from equation (4) by using the public key a. However, even when equation (5) is executed by using the other public key b, the inverse operation in the layer direction cannot be implemented because of the unidirectional property of F( ). Hence, access keys for higher layers cannot be obtained.

ii. An access key KRL0m is transferred to a user B who can access the data of lowest resolution and highest layer. The user B can generate access keys KRL0,m−1 to KRL00 from equation (5) by using the public key b. However, access keys for higher resolutions cannot be obtained because of the unidirectional property of F( ).

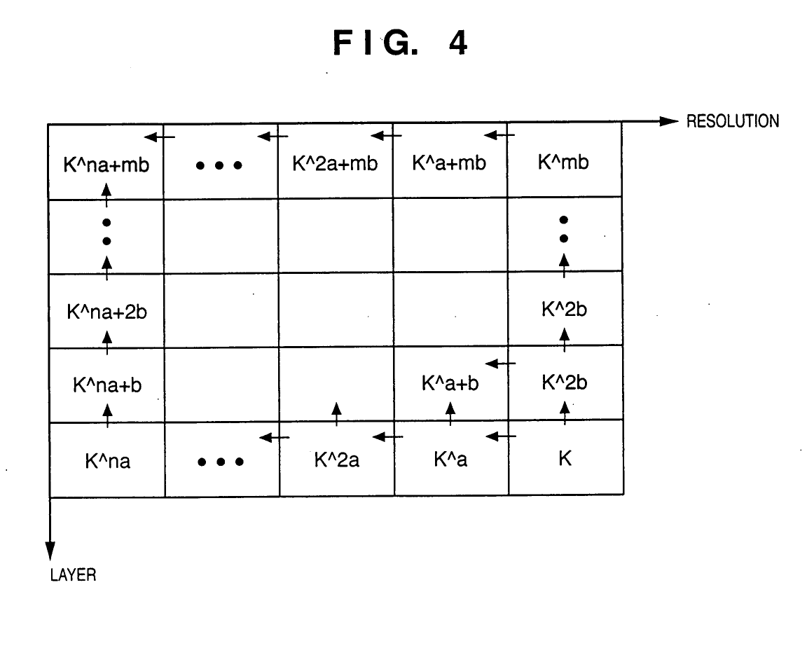

iii. Assume that the users A and B tell the access keys KRLn0 and KRL0m to each other in conspiracy. However, the access keys KRLn0 and KRL0m can only be used to generate the keys in the above-described ranges. Keys outside the ranges cannot be generated. FIG. 4 illustrates the above principle by using equation (7).

FIG. 4 indicates the following meaning. An access key K is set for the highest resolution and highest layer (plane of bit 0) of a given tile. Using the access key K as the origin, access key information is generated in the direction indicated by arrows in FIG. 4 (unidirectionally).

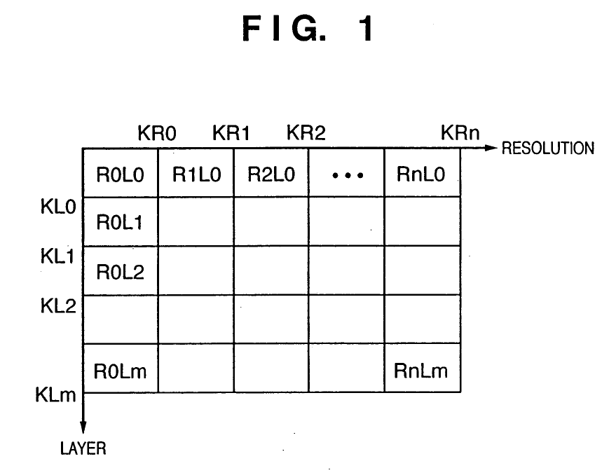

As a result, even when, e.g., the user A acquires a key “K\hat{ }mb” (the bit plane of highest resolution and lowest layer (MSB)), the user B acquires a key “K\hat{ }nb”, and they exchange the key information, it is substantially impossible to generate the key K. A much higher resistance against conspiracy of a plurality of users can be held than the prior art described in FIG. 1.

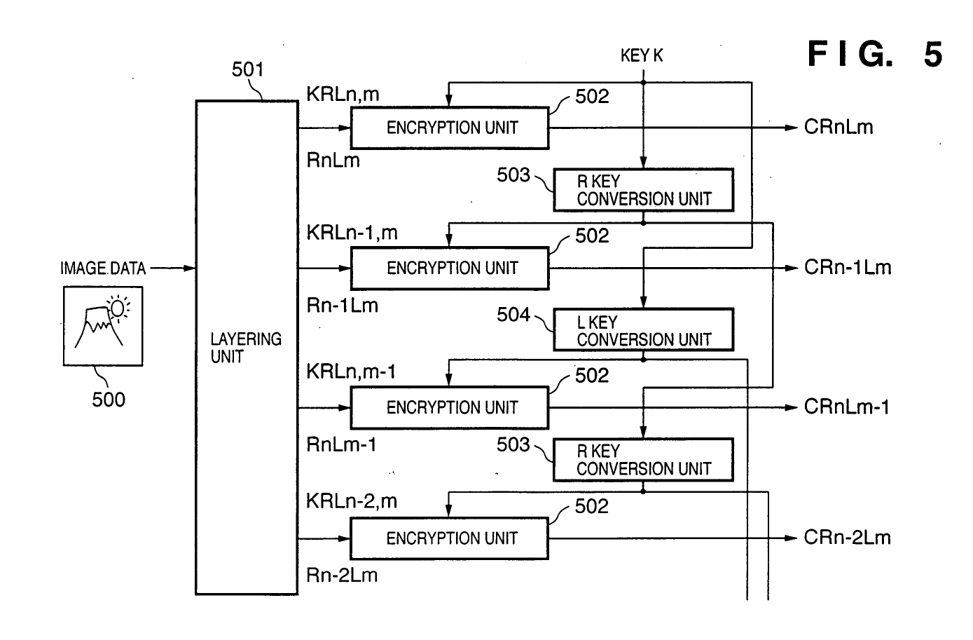

A processing unit which generates access keys for resolutions and layers and an encryption unit can be implemented by the arrangement shown in FIG. 5. Note that each processing unit shown in FIG. 5 can be regarded as a function of software.

For the descriptive convenience, assume that that a tile or component is not layered.

When image data 500 is input, a layering unit 501 converts the image 500 into various data of higher to lower resolutions and higher to lower layers as shown in FIG. 2. Assume that RnLm, Rn-1Lm, RnLm-1, Rn-2Lm, . . . are output sequentially from the highest level.

Let K be the access key information for the layered data RnLm of the highest resolution and highest layer. The key K=KRLnm. By using this key, RnLm is encrypted by an encryption unit 502. Although the encryption method used by the encryption unit 502 is not particularly limited here, various encryption methods such as DES or AES can be used. As a result, CRnLm obtained by encrypting RnLm is output (CRiLj indicates data obtained by encrypting RiLj).

On the basis of the key K, key updating in the direction of resolution is executed by an R key conversion unit 503 by using equation (4). Key updating in the direction of the layer is executed by an L key conversion unit 504 by using equation (5). Hence, the R key conversion unit calculates and outputs KRLn-1,m=K\hat{ }a from the key K=KRLnm. Similarly, the L key conversion unit calculates and outputs KRLn,m⁻¹=K\hat{ }b from the key K=KRLnm. The values a and b are set in the conversion units 503 and 504 in advance. Encoded data Rn-1Lm and RnLm-1 output from the layering unit 501 are encrypted by the encryption units 502 by using those keys.

After this, in the direction of resolution, the R key conversion unit calculates equation (4) by using, as an input, the key corresponding to the preceding resolution. In the direction of layer, the L key conversion unit calculates equation (5) by using, as an input, the key corresponding to the preceding layer. In this way, keys are updated. Succeeding hierarchical structure data are encrypted by using the updated keys. A key for data in an oblique direction and, for example, a key K\hat{ }(a+b) in FIG. 4, which corresponds to KRLn-1,m-1, can be calculated either by the R key conversion unit using, as an input, the preceding key K\hat{ }b in the direction of resolution or by the L key conversion unit using, as an input, the preceding key K\hat{ }a in the direction of layer because the same result can be obtained.

Decryption processing for these data can be implemented by an arrangement in which the encryption units 502 shown in FIG. 5 are replaced with decryption units corresponding to the encryption method of the encryption units 502, as is apparent.

In this embodiment, a tile or component is not layered for the descriptive convenience. Even when a tile, precinct, or component is layered, an access key KT, KC, or KP is generated in accordance with equation (1). An access key for the whole can be generated not by equation (3) but by

Ktcpr1=H(KT∥KC∥KP∥KRL) (8)

where KRL is the keys for the resolution and layer described in this embodiment.

To make correlation between components such as a tile, precinct, and component, keys c, d, and e are defined for the tile, precinct, and component to generate multi-dimensional layer data. Accordingly, conspiracy of users can be prevented by the same method as described above.

In the embodiment, equation (7) has been described as a method for ensuring the relations (4) to (6). However, the present invention is not limited to this. For example, the elliptic curve power remainder operation may be used.

In the first embodiment, updating of access keys for the resolution and layer is executed by using the public keys a and b. However, relations given by

KRLi−1,j=E(KRLij) (9)

KRLi,j−1=G(KRLij) (10)

E(G(K))=G(E(K)) (11)

may be satisfied.

As described above, according to this embodiment, even when image data having a plurality of tiles and hierarchical structures is encrypted by using different encryption keys for the respective tiles and hierarchical structures, leakage or illicit access by key information exchange between a plurality of users can be prevented. In addition, management of a plurality of keys is unnecessary.

In the example described in this embodiment, a resolution and layer are applied to two axes shown in FIG. 4 has been described. However, a tile, precinct, or component may be assigned to one or both of the axes. For a tile or precinct, multilevels are handled as position information.

<Second Embodiment>

There are more opportunities to distribute digital contents of document or image data through communication lines or mass recording media such as DVDs. In such a content distribution service, content providers that distribute contents are present. A content provider must set different pieces of access control information for the plurality of contents. It is assumed that encryption processing is executed using different encryption keys for the respective contents, users, or user actions (e.g., browsing and copy). In this processing, management related to key information such as key generation, key holding, and key distribution often heavily loads the content provider. In relation to the key management, studies have been carried on to find methods of more efficiently managing keys without degrading the security level. Some of these methods will be described. Especially, in the first embodiment, an example in which no hash function is used has been described. In the second embodiment, however, a method using a hash function as a one-way function will be described.

[Tree Structure Management Method]

A tree structure management method is used in an offline content reconstruction device such as a DVD player. This method is suitable for invalidating users. In this method, to allow only an authentic user to decrypt encrypted data, an encrypted content and key information used for encryption are simultaneously distributed or stored in a medium together. An appropriate combination of key information must be distributed to each user in advance. However, when a tree structure is used, an enormous amount of user key information can efficiently be managed.

In this management method, the three following indicators are used to determine whether the method is appropriate: 1) the data size of key information which is distributed simultaneously with a content, 2) the data size of key information which is distributed in advance to hold a user, and 3) the data size of key information that the content provider must manage. In an online distribution service, indicator 1) which influences the network traffic is regarded as important. From the viewpoint of the content provider, however, the management cost represented by indicator 3) is regarded as most important. That is, note that the weight of indicator changes depending on the situation.

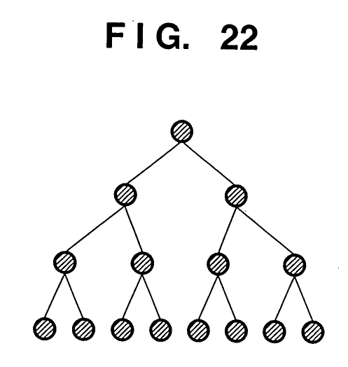

A typical example of the tree structure management method is a content distribution model (e.g., “Digital Content Protection Management Method” SCIS2001, pp. 213-218). In this model, a tree structure for key distribution as shown in FIG. 22 is used. Different keys are laid out in the respective nodes. A user key (in the above paper, a user key assumes a key held by a DVD player or the like) is regarded as the same as an end node (leaf node). It is assumed that all key data from the root to the end nodes are held. This model assumes that updating frequently occurs. Hence, with this layout, the efficiency of key invalidation is increased.

[Hierarchical Key Management Method]

In key management assumed by the hierarchical key management method, keys are laid out in the respective nodes, as in the tree structure management method. However, the hierarchical key management method is different from the tree structure management method in that keys located in all nodes including not only the end nodes but also the root are distributed to the user (e.g., C. H. Lin. “Dynamic key management schemes for access control in a hierarchy”, Computer Communications, 20: pp. 1381-1385, 1997, or J. C. Birget, X. Zou, G. Noubir, and B. Ramamurthy, “Hierarchy-Based Access Control in Distributed Environments”, in the proceedings of IEEE ICC, June 2001).

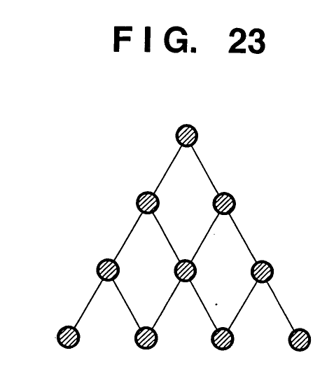

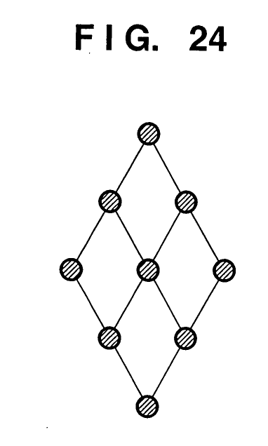

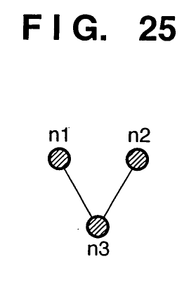

The hierarchical key management method assumes not an n-ary tree as shown in FIG. 22 but an access structure as shown in FIG. 23 or 24. Structures having a relationship shown in FIG. 25 are present locally. In this case, a mechanism must be provided, which can generate a key to be held by a node n3 from both a key laid out in a node n1 and that laid out in a node n2. To provide this mechanism, the two following methods have been proposed.

[(1) User Multiple Keying]

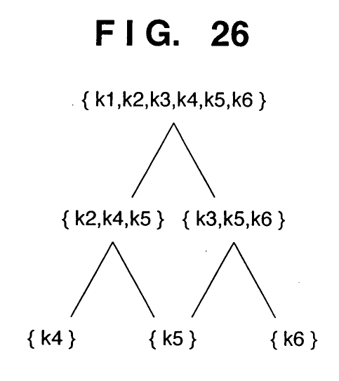

In this method, each node holds a plurality of keys. A parent node holds all keys of child nodes. FIG. 26 shows an example, in which sets of key data distributed to the respective nodes are shown. For example, the parent nodes of a node to which {k5} is distributed contain key data k5. Similarly, in the remaining nodes, a parent node contains all key data of child nodes.

[(2) One-Way Function Based Keying Schemes]

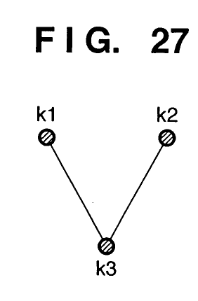

This method is extended from the proposal by Lin et al (nonpatent reference 2). When a one-way hash function is used, the amount of key information held by each node can be reduced. However, when the key data of a child node is to be generated from the key data of a plurality of parent nodes, as shown in FIG. 25, the following operation is necessary. This operation will be described with reference to FIG. 27.

Referring to FIG. 27, to generate k3 from key data k1 or k2,

k3: =F(k1,n3)XOR r13

k3: =F(k2,n3)XOR r23

are calculated, where XOR is an exclusive OR for each bit, Fo is a one-way hash function (to be described later in detail), n3 is the identifier of a node associated with the key data k3, r13 and r23 are, respectively, random data associated with the node n1 (key data k1) and node n3 and random data associated with the node n2 (key data k2) and node n3, both of which are data open to the public.

The function F( ) is constituted by F(k_i,n_j)=g\hat{ }{k_i+n_j} mod p (p is a prime number, and g is a primitive element). The values r13 and r23 are generated such that F(k1,n3) XOR r13=F(k2,n3) XOR r23 is satisfied.

As described above, when two or more parent nodes are locally present in the hierarchical key management method (in the example shown in FIG. 25, two parent nodes are present), the same key data is generated from different parent nodes in the above-described first embodiment.

In (1) user multiple keying, however, each node must have a number of keys. As the hierarchy becomes deep, the amount of key data to be held increases in proportion to the total number of nodes. In (2) one-way function based keying schemes, the amount of key data held by each node is decreased by using a one-way hash function. However, public random data such as r13 and r23 must independently be held. As in (1), as the hierarchy becomes deep, the amount of data to be held increases.

Additionally, in (2), the power operation is used for the one-way hash function. A hash function with trapdoor may also be used. In either case, operations which require the power operation are included, and the calculation cost is large. Especially, in a device such as PDA with a small amount of operation resources consumes a long time for key calculation. As a result, interactive processing may be impossible at the time of data decryption.

In the second and third embodiments, this problem is taken into consideration. An example will be described, in which a key management method having the same access structure as that of the hierarchical key management method is safely constructed in a small calculation amount.

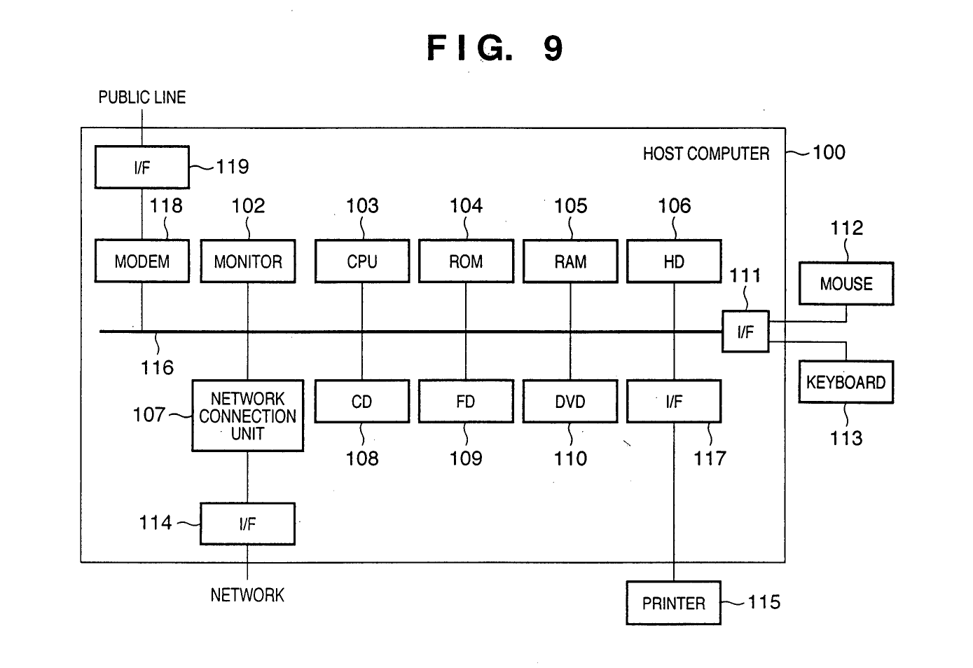

FIG. 9 is a block diagram schematically showing the arrangement of a key information processing apparatus according to the second embodiment.

In implementing the present invention, it is not essential to use all functions shown in FIG. 9.

Referring to FIG. 9, a key information processing apparatus 100 comprises a modem 118 of a public line or the like, a monitor 102 serving as a display unit, a CPU 103, a ROM 104, a RAM 105, an HD (Hard Disk) 106, a network connection unit 107 of a network, a CD 108, an FD (Flexible Disk) 109, a DVD (Digital Video Disk or Digital Versatile Disk) 110, an interface (I/F) 117 of a printer 115, and an interface (I/F) 111 of a mouse 112 and keyboard 113 serving as an operation unit. These components are connected through a bus 116 to be communicable with each other.

The mouse (registered trademark) 112 and keyboard 113 serve as operation units through which the user inputs various instructions to the key information processing apparatus 100. Information (operation information) input through the operation units is received by the key information processing apparatus 100 through the interface 111.

Various kinds of information (character information and image information) in the key information processing apparatus 100 can be printed and output by the printer 115.

The monitor 102 displays various kinds of instruction information to the user or various kinds of information such as character information and image information.

The CPU 103 controls the operation of the entire key information processing apparatus 100. The CPU 103 controls the entire key information processing apparatus 100 by reading out a processing program (software program) from the HD (Hard Disk) 106 and executing the program. Especially, in the second embodiment, the CPU 103 reads out a processing program which implements key generation from the HD 106 and executes the program to execute information processing to be described later.

The ROM 104 stores a key generation processing program and various kinds of data (e.g., a key generation graph) used in the program.

The RAM 105 is used as a working area to temporarily store the processing program or information to be processed for various kinds of processing in the CPU 103.

The HD 106 is a constituent element as an example of a mass storage device. The HD 106 stores various kinds of data and a processing program for information conversion processing, which is transferred to the RAM 105 in executing various kinds of processing.

The CD (CD drive) 108 has a function of reading out data stored on a CD (CD-R) as an example of an external storage medium and writing data on the CD.

The FD (Floppy (R) Disk drive) 109 reads data stored on the FD 109 as an example of an external storage medium, like the CD 108. The FD 109 also has a function of writing various data on the FD 109.

The DVD (Digital Video Disk) 110 has a function of reading out data stored on the DVD 110 as an example of an external storage medium and writing data on the DVD 110, like the CD 108 and FD 109.

When, e.g., an editing program or printer driver is stored on an external storage medium such as the CD 108, FD 109, or DVD 110, the program may be installed in the HD 106 and transferred to the RAM 105, as needed.

The interface (I/F) 111 receives a user input from the mouse 112 or keyboard 113.

The modem 118 is a communication modem which is connected to an external network through an interface (I/F) 119 and, e.g., a public line.

The network connection unit 107 is connected to an external network through an interface (I/F) 114.

Key generation/management by the above-described apparatus will be described below.

[Outline of Key Generation]

Generation of a node key of each node in the hierarchical key management method according to the second embodiment will be described first.

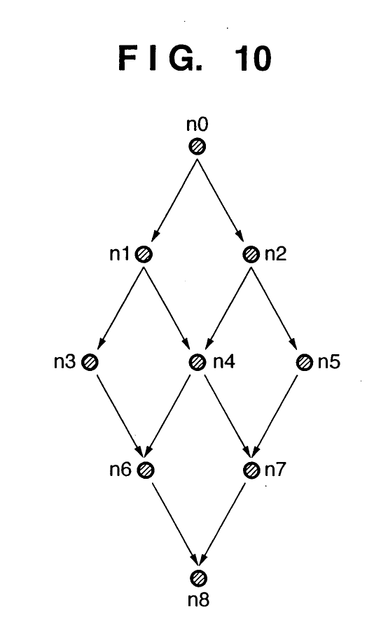

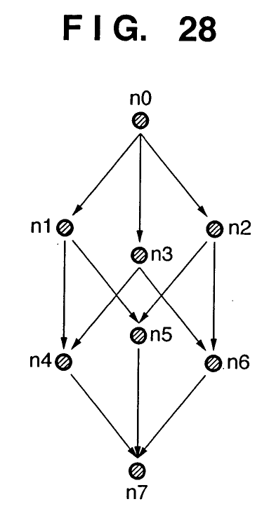

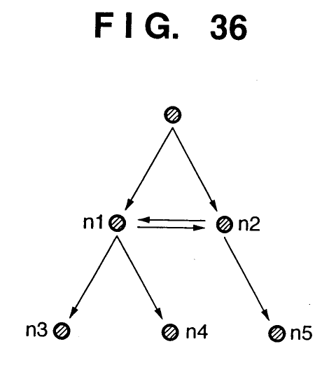

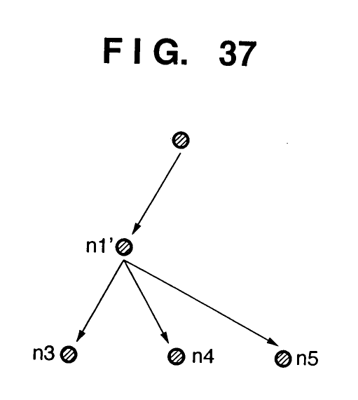

In the second embodiment, assume that the hierarchical relationship is expressed by a digraph having neither a loop nor a cycle, as shown in FIG. 10 or 28. When a plurality of different nodes are connected to each other by a digraph, like nodes n1 and n2 in FIG. 36, these nodes are handled together as one node such that the structure can be returned to a structure in which no nodes have such a bidirectional connection relationship. FIG. 37 shows a digraph which regards the nodes n1 and n2 as one node n1′. Assume that no nodes have such a bidirectional connection relationship.

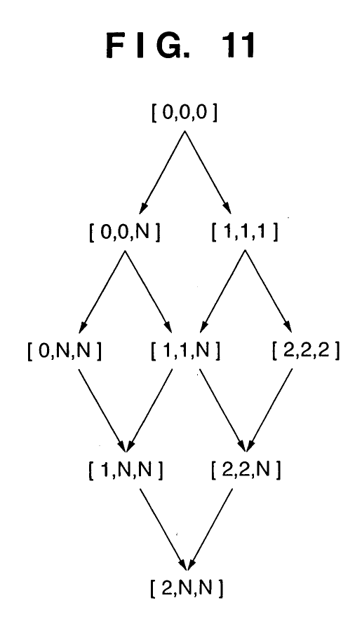

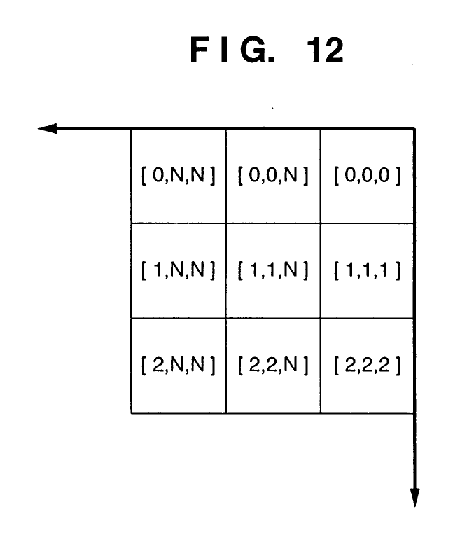

For the descriptive convenience, a matrix graph having two layers as shown in FIG. 10 is used in this embodiment. Referring to FIGS. 11 and 12, three numbers in each cell represent the number of times of hash function calculation executed for three initial keys x, y, and z. For example, a cell with [2,2,N] holds H(H(x)) and H(H(y)) as node keys. N indicates “nothing”, i.e., that there is no information about the initial key z. Executing hash calculation n times will be expressed by abbreviation H\hat{ }n( ) hereinafter. On the basis of this expression, the cell with [2,2,N] has two node keys H\hat{ }2(x) and H\hat{ }2(y). The tree structure in the hierarchical key management method may be replaced with the matrix shown in FIG. 12. FIG. 11 shows an example of a tree structure having nine nodes. The numbers of the nodes shown in FIG. 11 correspond to the numbers of the cells shown in FIG. 12.

The root node (the node indicated by [0,0,0] in FIG. 11) in the tree structure shown in FIG. 11 is made to correspond to the cell at the upper right corner of the matrix. Of the child nodes in the tree structure, the node located on the left side and that located on the right side are made to correspond to the left cell and lower cell in the matrix, respectively. When all nodes and cells are sequentially made to correspond to each other, the tree structure shown in FIG. 11 can be replaced with the matrix shown in FIG. 12.

A method of generating key generation data shown in FIG. 11 or 12 will be described next.

[Node Division]

To generate key generation data, nodes are divided in a given key distribution graph G such that the following conditions are satisfied. Let Node(G) be the total set of nodes, N be the size of a group of subsets, and SubG_{—}1, SubG_{—}2, . . . , SubG_N be divided subsets.

SubG_{—}1 ∪ SubG_{—}2 ∪ . . . ∪ SubG_N=Node(G) That is, the whole subsets include all nodes.

Two arbitrary different nodes n_a and n_b included in SubG_i have a relation given by

n_a<n_b or n_a>n_b

That is, n_a and n_b have a descendant relationship.

One node is always a descendant node of the other node.

The number N of divided subsets is called a key distribution order of a key distribution graph G and expressed by Ord(G).

[Node Key Assignment]

An initial key K_i is calculated for each subset SubG_i and assigned as the node key of the root node. Node keys are assigned to the descendant nodes under the root node in accordance with the following rules.

i) Each node is assigned a number associated with N initial keys K_i (1≦i≦N). This number represents the number of times of execution of a one-way function for the initial key K_i. “N” which means “nothing” may sometimes be assigned. When the number of the initial key K_i is “N”, it means that no key associated with the initial key K_i is held.

ii) The nodes included in SubG_i are sorted in descending order in each set in accordance with the descendant relationship on the digraph and assigned numbers which are increased by one from 0. These numbers are associated with the initial key K_i.

iii) As the number of each node included in SubG_i, which is associated with an initial key K_j (i≠j), N (nothing) is assigned when the node is not the ancestor node of the node included in SubG_j (a subset for the initial key K_j). As the number of an ancestor node, the minimum value of the numbers assigned to the nodes included in SubG_j as descendant nodes is assigned.

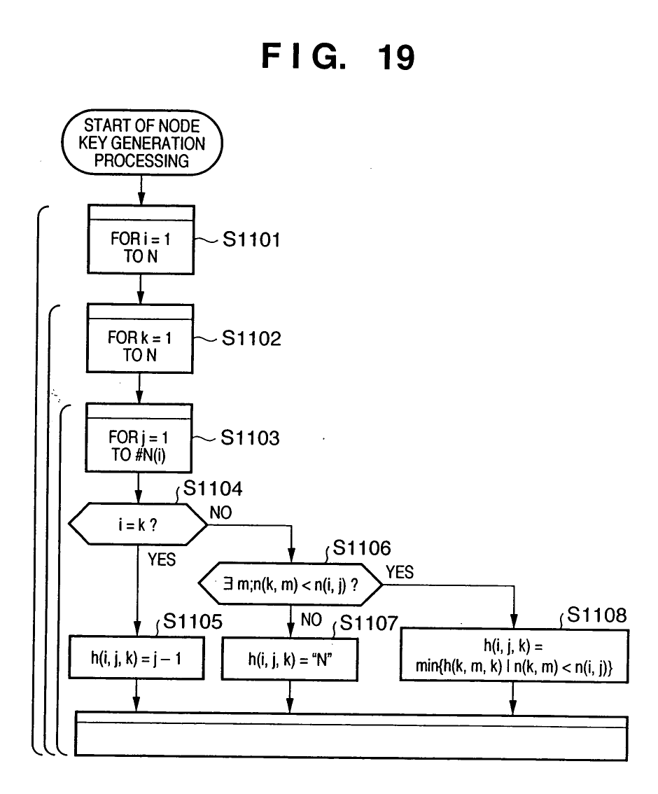

FIG. 19 is a flow chart of the above-described node key assignment processing. FIG. 19 will be described below. Assume that all the node sets are already divided into subsets {SubG_i} (1≦i≦N) which are disjoint sets and not empty sets, and the initial key K_i for each subset is calculated. The number of nodes included in the subset SubG_i is expressed by #N(i). The nodes included in the subset SubG_i are sorted in descending order in accordance with the descendant relationship on the digraph and expressed by SubG_i={n(i,1), n(i,2), . . . , n(i,#N(i))}. A node key for a node n(i,j) is obtained by executing a one-way hash function for an initial key K_k (1≦k≦N) a specified number of times. The specified number of times is expressed by h(i,j,k).

In step S1101, loop processing for a variable i which varies from 1 to N is executed. In step S1102, loop processing for a variable j which varies from 1 to N is executed. In step S1103, loop processing for a variable k which varies from 1 to #N(i) is executed. In step S1104, it is evaluated whether the variable i coincides with the variable k. If YES in step S1104, the processing advances to step S1105. If NO in step S1104, the processing advances to step S1106. In step S1105, j−1 is substituted into h(i,j,k), and the flow returns to the loop processing. In step S1106, it is evaluated whether a value m which satisfies n(k,m)<n(i,j), i.e., a condition that n(i,j) is the ancestor node of n(k,m) is present. If NO in step S1106, the processing advances to step S1107. If YES in step S1106, the processing advances to step S1108. In step S1107, “N” is substituted into h(i,j,k), and the flow returns to the loop processing.

In step S1108, min{h(k,m,k)|n(k,m)<n(i,j)}, i.e., the minimum value of h(k,m,k) of nodes for which n(i,j) is the ancestor node of n(k,m) is substituted into h(i,j,k), and the processing returns to the loop processing.

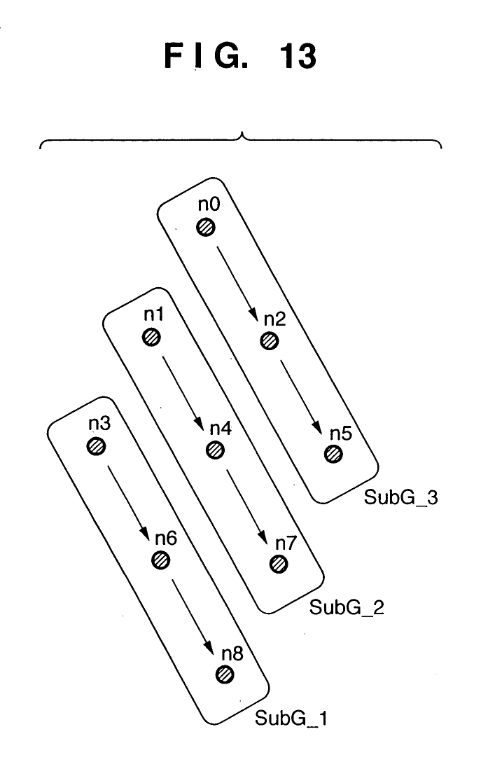

A detailed example will be described below with reference to FIGS. 13 to 16, 17, 18, and 28 to 34.

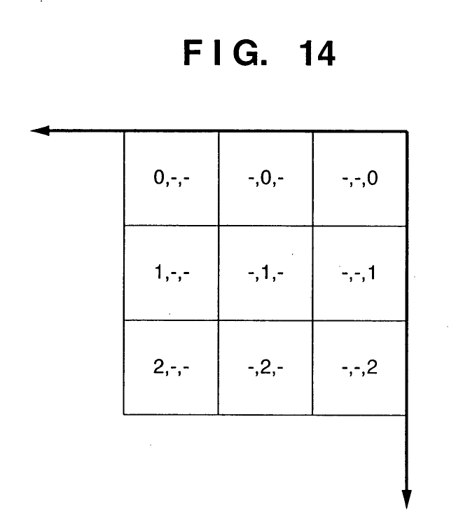

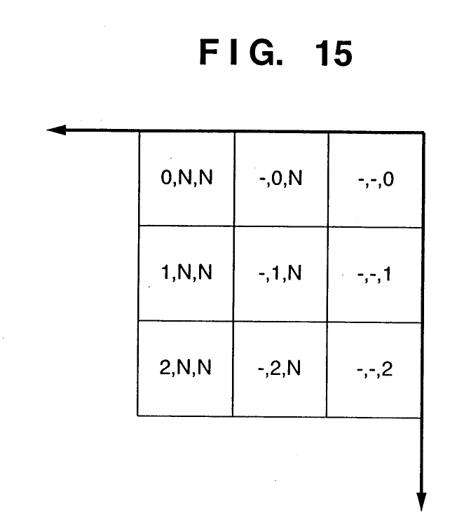

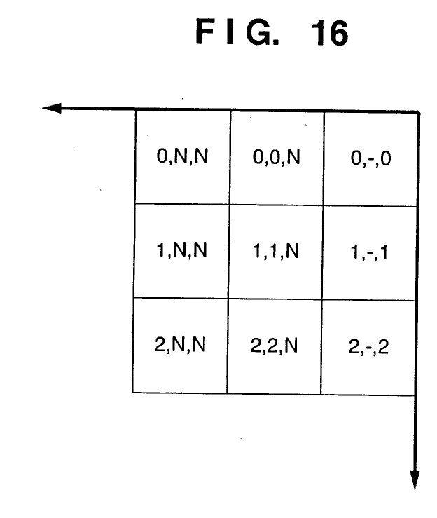

FIG. 13 shows an example of node division in the key generation graph shown in FIG. 10. The nodes are divided into three subsets SubG_{—}1 to SubG_{—}3. More specifically, SubG_{—}1={n0, n2, n5}, SubG_{—}2={n1, n4, n7}, and SubG_{—}3={n3, n6, n8}. FIG. 14 shows only h(i,j,k). For example, {h(1,1,1), h(1,2,1), h(1,3,1)}={0,1,2}. This corresponds to steps S1104 and S1105. FIG. 15 shows portions which are assigned “N” because of the descendant relationship between the nodes. For example, h(1,1,3)=“N”. This is because there is no value m which satisfies n(3,m)<n(1,1)=n3. Actually, n(3,1)=n0, n(3,2)=n2, and n(3,3)=n5, and this can be confirmed. This corresponds to steps S1106 and S1107. FIG. 16 shows a result on which all i and j which satisfy n(3,m)<n(i,j) are checked and reflected. For example, h(2,1,1)=0. The value m which satisfies n(1,m)<n(2,1)=n1 can be 1, 2, or 3. However, the minimum value of h(1,1,1)=0, h(1,2,1)=1, and h(1,3,1)=2, i.e., 0 is selected. In addition, all i and j which satisfy n(2,m)<n(i,j) are checked. FIG. 12 is obtained eventually.

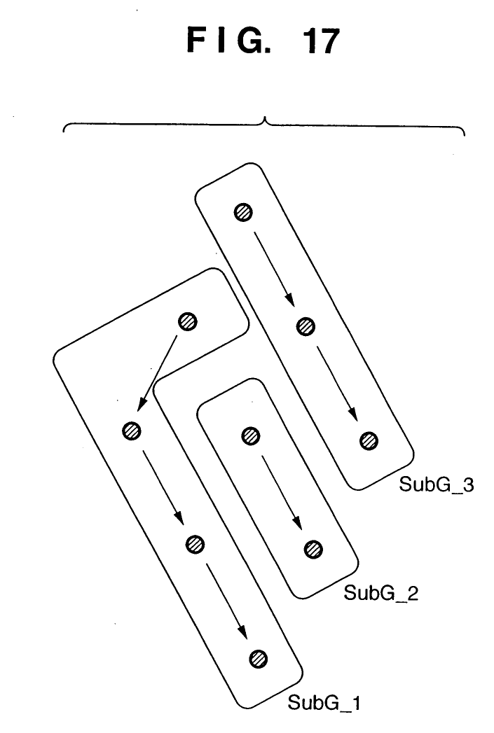

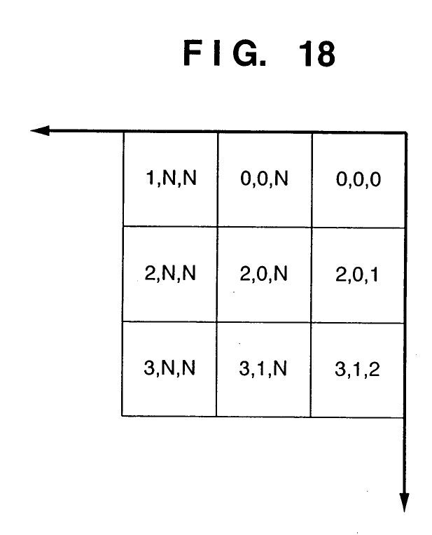

With the node key forming method by node division shown in FIG. 17, which is different from that shown in FIG. 13, a matrix similar to that in FIG. 12 can be obtained in accordance with a flow chart shown in FIG. 19, and a matrix shown in FIG. 18 is obtained. The total amount of hash calculation is larger in FIG. 18 than in FIG. 12.

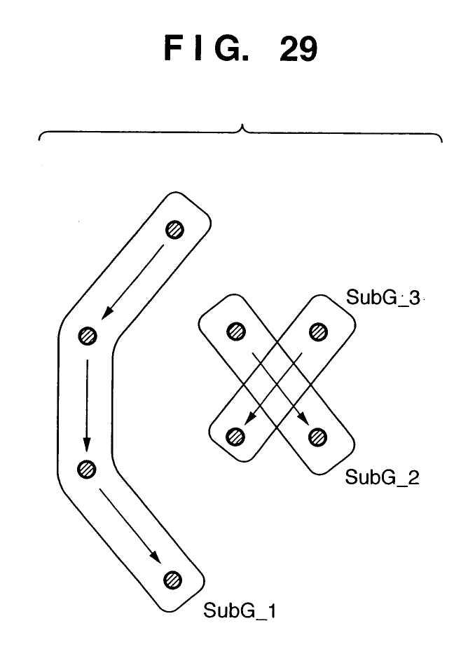

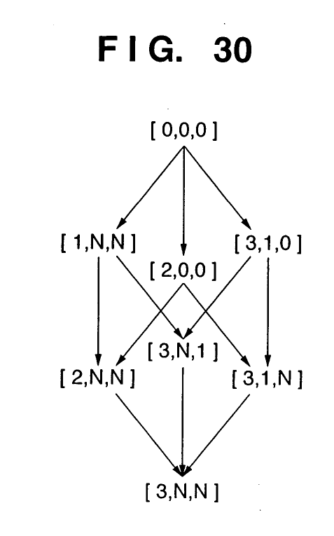

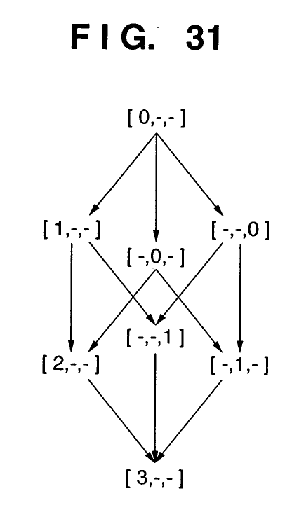

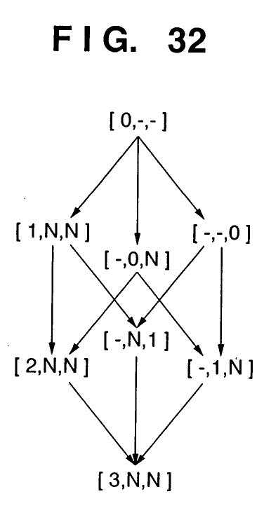

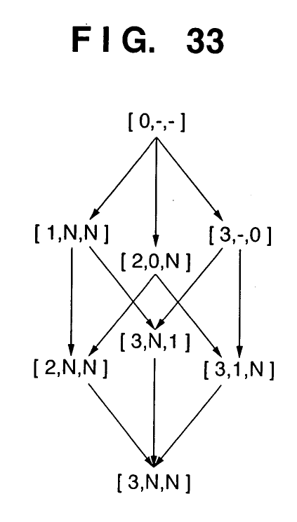

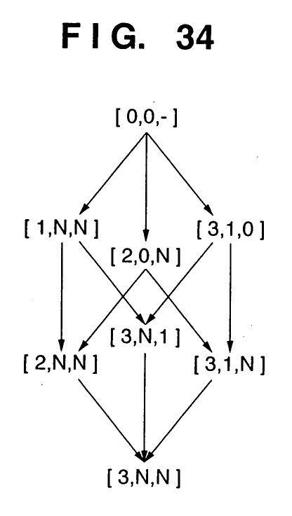

The node key forming method in the key generation graph shown in FIG. 28 will be described next. FIG. 29 shows an example of node division in the key generation graph shown in FIG. 28. The nodes are divided into the three subsets SubG_{—}1 to SubG_{—}3. More specifically, SubG_{—}1={n0, n1, n4, n7}, SubG_{—}2={n3, n6}, and SubG_{—}3={n2, n5}. FIG. 30 shows node keys formed on the basis of the flow chart shown in FIG. 19. The arrangement until FIG. 30 will be described below. FIG. 31 shows only h(i,j,i). For example, {h(1,1,1), h(1,2,1), h(1,3,1), h(1,4,1)}={0,1,2,3}. This corresponds to steps S1104 and S1105. FIG. 32 shows portions which are assigned “N” because of the descendant relationship between the nodes. For example, h(1,2,3)=“N”. This is because there is no value m which satisfies n(3,m)<n(1,2)=n1. Actually, n(3,1)=n3 and n(3,2)=n6, and this can be confirmed. This corresponds to steps S1106 and S1107. FIG. 33 shows a result on which all i and j which satisfy n(1,m)<n(i,j) are checked and reflected. For example, h(2,1,1)=2. The value m which satisfies n(1,m)<n(2,1)=n3 can be 3 or 4. However, the minimum value of h(1,3,1)=2 and h(1,4,1)=3, i.e., 2 is selected. FIG. 34 shows a result on which, in a similar way, all i and j which satisfy n(2,m)<n(i,j) are checked and reflected. FIG. 30 is obtained eventually.

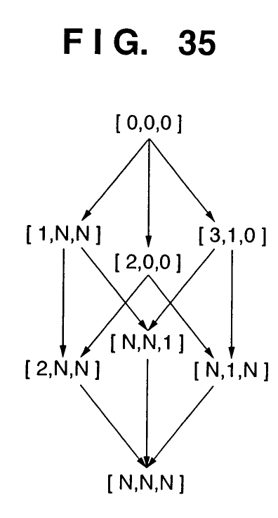

A case wherein no keys are distributed to the end node will be examined. In this state, for example, thumbnail images of image data can be accessed without limitations. FIG. 35 shows an example. [N,N,N] of the end node means that no node key is present. This state can be obtained by using the flow chart shown in FIG. 19 in a state wherein only the end node is excluded from all subsets in node division. In this example, no node keys are distributed to only one end node. The same structure can be obtained even when a plurality of nodes are present.

[Conditions to Be Satisfied by Generated Keys]

The above-described key generation method is designed to satisfy the following conditions.

a. Generativity: A target node can generate a key for its grandchild node.

b. Conspiracy attack avoidability: (Unless the one-way function is weak,) no keys can be generated for ancestor nodes located at an upper level of each node even when entities located in two or more arbitrary nodes conspire.

Under these conditions, the hierarchical key management method capable of safely generating and distributing keys can be implemented.

[Key Distribution]

A method of causing a root key distributor (the entity in the root node) to distribute keys to nodes and a method of causing an entity other than the root key distributor, which holds individual keys, to distribute keys to lower level nodes will be described. The root key distributor generates, safely and at random, parameters {x₁₃ 1} (1≦i≦Ord(G)) corresponding to the key distribution order Ord(G) determined by the key distribution graph G as individual keys of its own. The root key distributor also lays out a plurality of keys to the nodes in accordance with the above-described key generation procedures. The root key distributor safely distributes the keys for the nodes to entities located in the nodes. The root key distributor also makes the key distribution graph open to the public and distributes, to each entity, data which identifies the location of the distributed key in the graph. When a matrix graph is used as the key distribution graph, this data is formed from coordinates in expressing the matrix.

[Key Generation/Distribution Processing in Information Processing Apparatus]

A sequence for causing the key information processing apparatus 100 to execute the above-described key generation/distribution processing will be described. Data such as an image to be managed is acquired through the CD 108 or the network connection unit 107 of the network and stored in the HD 106, or selected from data already stored in the HD 106. The user selects the data from the list displayed on the monitor 102 by using the mouse 112 or keyboard 113.

When the user selects, by the same method as described above, an access control structure which defines, e.g., the number of layer axes in the data to be managed, a key generation graph corresponding to the structure is calculated by using the CPU 103 and stored in the RAM 105 or HD 106.

Random data is generated from, e.g., data in the ROM 104, RAM 105, or HD 106 or the operation of the mouse 112. A plurality of original keys are generated by using the random data and stored in the RAM 105 or HD 106. Individual keys for nodes in the key generation graph are calculated from the original keys and stored in the RAM 105 or HD 106.

The individual keys stored in the RAM 105 or HD 106 are read out and distributed to another information processing apparatus through the network connection unit 107 of the network.

<Third Embodiment>

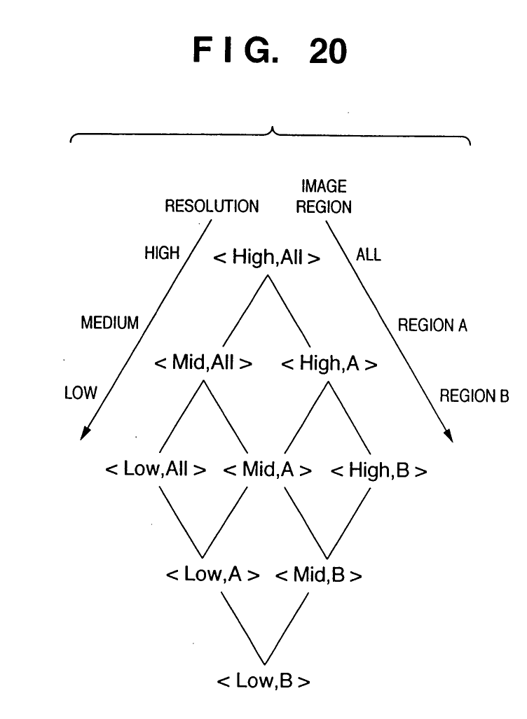

A preferable example of access control using key data having a hierarchical structure generated by the key distribution method according to the second embodiment will be described. The matrix key generation graph shown in FIG. 10 has two layer axes. FIG. 20 shows an example in which one layer axis (toward the lower left) represents the resolution, and the other layer axis (toward the lower right) represents the image region.

The resolution has three levels: high, medium, and low levels, and represents an acquirable image resolution. The image region also has three levels and authorizes a user to browse all regions, sub-region A, or sub-region B (smaller than the sub-region A). The node which is located at the root with the largest authority is assigned (resolution=high, and image region=all). The node of lowest level is assigned (resolution=low, and image region=region B).

A key distribution method and image encryption method will be described by using an example of key distribution according to FIG. 11 or 12 will be described. Target image data IMG is divided into image data IMG_{—}1 of region B, region A differential data IMG_{—}2, and differential data IMG_{—}3 to obtain all image data. That is, IMG=IMG_{—}1+IMHG_{—}2+IMG_{—}3. Each image data IMG_i is divided into low resolution data IMG_i(L), medium resolution differential data IMG_i(M), and high resolution differential data IMG_i(H). That is IMG_i=IMG_i(L)+IMG_i(M)+IMG_i(H).

The root key distributor generates original keys x, y, and z at random. A key to be used for encryption is generated as Key(<High,All>): =H(x∥y∥u), and IMG_{—}3(H) is encrypted by using this key. ∥ means connection of data. In each child node, three acquired data are connected to generate an encryption key, as in the root node, so that the data shown in FIG. 12 is encrypted.

For example, in<Mid,All>node, H(x), H\hat{ }3(y), and u are given as key data. An encryption key is generated as Key(<Mid,All>): =H(H(x)∥H\hat{ }3(y)∥u), and IMG_{—}3(M) is encrypted by using this key. To decrypt the encrypted data, an encryption key is calculated by similar processing, and decryption processing is executed to acquire appropriate image data.

In this embodiment, the method of connecting keys and hashing them is employed as the encryption key generation method. However, any other key connection method (a method of calculating one key from a plurality of key data) may be used.

In this embodiment, the resolution and image region are used as the layer axes. However, the present invention is not limited to this. Two or more arbitrary layers may be selected from layers such as the image quality, time axis, and use control information, which are to be access-controlled.

<Other Embodiment by Software>

The present invention may be applied as part of a system constituted by a plurality of devices (e.g., a host computer, an interface device, a reader, a printer, and the like) or part of an apparatus comprising a single device (e.g., a copying machine, a facsimile apparatus, or the like).

The present invention is not limited to the apparatus and method to implement the above-described embodiments and a method which combines the methods described in the embodiments. The present invention also incorporates a case wherein the above-described embodiments are implemented by supplying software program codes for implementing the above-described embodiments to a computer (or a CPU or MPU) in the system or apparatus and causing the computer in the system or apparatus to operate various devices in accordance with the program codes.

In this case, the software program codes themselves implement the functions of the above-described embodiments. The program codes themselves and a means for supplying the program codes to the computer and, more specifically, a storage medium which stores the program codes are incorporated in the present invention.

As such a storage medium which stores the program codes, for example, a floppy (R) disk, hard disk, optical disk, magnetooptical disk, CD-ROM, magnetic tape, nonvolatile memory card, or ROM can be used.

The present invention incorporates not only the case wherein the functions of the above-described embodiments are implemented by causing the computer to control various devices in accordance with only the supplied program codes but also a case wherein the functions of the above-described embodiments are implemented by causing the program codes to cooperate with the OS (Operating System) running on the computer or another application software.

The present invention also incorporates a case wherein after the supplied program codes are stored in the memory of the function expansion board of the computer or the function expansion unit connected to the computer, the CPU of the function expansion board or function expansion unit performs part or all of actual processing on the basis of the instructions of the program codes to implement the functions of the above-described embodiments.

As described above, according to the present invention, an image data encryption technique can be provided, which facilitates management of access keys in encrypting image data having a hierarchical structure in which the data of each layer can be specified by at least two parameters, and is resistant against exchange of access keys between a plurality of users.

As many apparently widely different embodiments of the present invention can be made without departing from the spirit and scope thereof, it is to be understood that the invention is not limited to the specific embodiments thereof except as defined in the appended claims.

What is claimed is:

1. An image data encryption method of encrypting image data by using key information, comprising:
an input step of inputting image data which has a hierarchical structure and in which data of each layer can be specified by at least two parameters, and each parameter is expressed by multilevels;
a setting step of setting, for the input image data, key information for data of a layer in which said at least two parameters are specified by predetermined levels;
a generation step of, by using the key information set in the setting step as an origin and by using a predetermined one-way function, generating key information for data of a layer specified by said at least two parameters, in accordance with key information for a layer which is located at a level higher than the data of the layer; and
an encryption step of encrypting data of a layer of interest, which is input in the input step, in accordance with the key information set in the setting step and the key information generated in the generation step.

2. The method according to claim 1, wherein the key information to be generated in the generation step can be generated from any key information generated for higher levels of said at least two parameters.

3. The method according to claim 1, wherein the image data input in the input step is data encoded (compressed) by JPEG2000, and the parameters includes one of a tile, a precinct, a component, a resolution, or a layer.

4. The method according to claim 1, wherein in the generation step, the key information is generated in accordance with a public key encryption method.

5. The method according to claim 1, wherein in the generation step, the key information is generated by an elliptic curve shaped remainder operation.

6. The method according to claim 1, wherein the one-way function used in the generation step is a hash function.

7. An image data encryption apparatus for encrypting image data by using key information, comprising:
input means for inputting image data which has a hierarchical structure and in which data of each layer can be specified by at least two parameters, and each parameter is expressed by multilevels;
setting means for setting, for the input image data, key information for data of a layer in which said at least two parameters are specified by predetermined levels;
generation means for, by using the key information set by said setting means as an origin and by using a predetermined one-way function, generating key information for data of a layer specified by said at least two parameters, in accordance with key information for a layer which is located at a level higher than the data of the layer; and
encryption means for encrypting data of a layer of interest, which is input by said input means, in accordance with the key information set by said setting means and the key information generated by said generation means.

8. The apparatus according to claim 7, wherein the key information to be generated by said generation means can be generated from any key information generated for higher levels of said at least two parameters.

9. The apparatus according to claim 7, wherein the image data input by said input means is data encoded (compressed) by JPEG2000, and the parameters includes one of a tile, a precinct, a component, a resolution, or a layer.

10. The apparatus according to claim 7, wherein said generation means generates the key information in accordance with a public key encryption method.

11. The apparatus according to claim 7, wherein said generation means generates the key information by an elliptic curve shaped remainder operation.

12. The apparatus according to claim 7, wherein the one-way function used by said generation means is a hash function.

13. A computer program which functions as an image data encryption apparatus for encrypting image data by using key information, functioning as:
input means for inputting image data which has a hierarchical structure and in which data of each layer can be specified by at least two parameters, and each parameter is expressed by multilevels;
setting means for setting, for the input image data, key information for data of a layer in which said at leas two parameters are specified by maximum levels;
generation means for, by using the key information set by said setting means as an origin and by using a predetermined one-way function, generating key information for data of a layer specified by said at least two parameters, in accordance with key information for a layer which is located at a level higher than the data of the layer; and
encryption means for encrypting data of a layer of interest, which is input by said input means, in accordance with the key information set by said setting means and the key information generated by said generation means.

14. A computer-readable storage medium storing a computer program of claim 13.

15. An method for generating key information used for encrypting or decrypting image data which has a hierarchical structure and in which data of each layer can be specified by at least two parameters, and each parameter is expressed by multilevels, said method comprising;
an acquisition step of acquiring, for the input image data, key information for data of a layer in which said at least two parameters are specified by predetermined levels; and
a generation step for, by using the key information acquired in said acquisition step as an origin and by using a predetermined one-way function, generating key information for data of a layer specified by said at least two parameters, in accordance with key information for a layer which is located at a level higher than the data of the layer.
